(19) United States
(12) Patent Application Publication
(10) Pub. No.: US 2018/0327640 A1
(43) Pub. Date: Nov. 15, 2018

(54) PRESSURE SENSITIVE ADHESIVE COMPRISING (METH)ACRYLIC POLYMER COMPRISING EPOXY-FUNCTIONAL GROUPS AND TRIAZINE CROSSLINKER

(71) Applicant: 3M INNOVATIVE PROPERTIES COMPANY, St. Paul, MN (US)

(72) Inventors: Stefan H. Gryska, Woodbury, MN (US); Hae-Seung Lee, Woodbury, MN (US); Arlin Weikel, Mansfield, PA (US); Anish Kurian, Woodbury, MN (US); Babu N. Gaddam, Woodbury, MN (US)

(21) Appl. No.: 15/575,414

(22) PCT Filed: May 9, 2016
(86) PCT No.: PCT/US2016/031405

§ 371 Date: Nov. 20, 2017

Related U.S. Application Data
(60) Provisional application No. 62/162,943, filed on May 18, 2015.

(51) Int. Cl. C09J 133/06; C09J 7/38

(52) U.S. Cl. CPC C09J 133/068; C09J 7/385; C08K 5/3492; C09J 2205/31; C09J 2205/102

(57) ABSTRACT

Presently described are methods of preparing a pressure sensitive adhesive composition comprising providing a non-aqueous pressure sensitive adhesive comprising a (meth)acrylic copolymer comprising epoxy-functional groups; adding a chlorinated triazine crosslinker to the pressure sensitive adhesive; and coating the pressure sensitive adhesive onto a substrate. In some embodiments, the method may further comprise contacting the pressure sensitive adhesive to a second substrate. The method further comprises exposing the pressure sensitive adhesive to actinic radiation to crosslink the epoxy-functional groups by means of the triazine crosslinker. The step of exposing can occur at the time of manufacture (e.g. of a pressure sensitive adhesive coated articles such as a tape) or at the time of use. Also described are non-aqueous pressure sensitive adhesive compositions and adhesive-coated articles.

### BACKGROUND

WO2012/091817 (abstract) describes a crosslinkable composition comprising an acid- and epoxy-functional copolymer, which when crosslinked with a triazine crosslinking agent provides a pressure-sensitive adhesive and pressure-sensitive adhesive articles.

WO2012/161997 (abstract) describes a pre-adhesive composition comprising an acid- and epoxy-functional (meth)acryloyl copolymer, which when crosslinked using an ionic photoacid generator (PAG) provides a pressure-sensitive adhesive and pressure-sensitive adhesive articles having desirable properties.

WO2012/177337 (abstract) describes a pre-adhesive composition comprising an epoxy-functional (meth)acryloyl copolymer and epoxy resin, which when crosslinked using an ionic photoacid generator (PAG) provides a pressure-sensitive adhesive and pressure-sensitive adhesive articles having desirable properties.

WO2014/164000 (abstract) describes adhesive compositions and methods of preparing an adhesive composition. The method comprises providing a syrup composition comprising a free-radically polymerizable solvent monomer and a solute (meth)acrylic copolymer, and radiation curing the syrup composition in the absence of an ionic photoacid generator. The solute (meth)acrylic copolymer comprises epoxy-functional groups, acid-functional groups, or a combination thereof. In some embodiments, an epoxy resin having on average greater than one polymerizable epoxy group per molecule or an acid comprising at least two carboxylic acid groups is utilized. The epoxy-functional groups and acid-functional groups of the (meth)acrylic copolymer or the adhesive composition can readily crosslink in the absence of an ionic photoacid generator (PAG).

### SUMMARY

In one embodiment, a method of preparing a pressure sensitive adhesive composition is described. The method comprises providing a non-aqueous pressure sensitive adhesive comprising no greater than 5 wt-% polymerizable monomer and a (meth)acrylic copolymer comprising epoxy-functional groups; adding a chlorinated triazine crosslinker to the pressure sensitive adhesive; and coating the pressure sensitive adhesive onto a substrate. In some embodiments, the method may further comprise contacting the pressure sensitive adhesive to a second substrate. The method further comprises exposing the pressure sensitive adhesive to actinic radiation to crosslink the epoxy-functional groups by means of the triazine crosslinker. The step of exposing can occur at the time of manufacture (e.g. of a pressure sensitive adhesive coated article such as a tape) or at the time of use.

In another embodiment, an adhesive-coated article is described comprising a substrate (e.g. release liner or backing); and a non-aqueous pressure sensitive adhesive comprising no greater than 5 wt-% polymerizable monomer disposed on the substrate; wherein the adhesive comprises a (meth)acrylic copolymer comprising epoxy-functional groups and a triazine crosslinker.

In another embodiment, a pressure sensitive adhesive composition is described comprising a (meth)acrylic copolymer comprising epoxy-functional group and a triazine crosslinker. The pressure sensitive adhesive is non-aqueous and comprises no greater than 5 wt-% polymerizable monomer.

### DETAILED DESCRIPTION

Herein, “(meth)acrylic” includes both methacrylic and acrylic.

Herein, “(meth)acrylate” includes both methacrylate and acrylate.

The term “hydrocarbyl” means a saturated or unsaturated linear, branched, cyclic, or polycyclic hydrocarbon group. Unless otherwise indicated, the hydrocarbyl groups typically contain up to 30 carbon atoms, often up to 20 carbon atoms, and even more often up to 10 carbon atoms. This term is used to encompass alkyl, alkenyl, alkynyl groups, as well as cyclic groups such as alicyclic and aromatic groups, for example.

Herein, “alkyl” includes straight-chained, branched, and cyclic alkyl groups and includes both unsubstituted and substituted alkyl groups. Unless otherwise indicated, the alkyl groups typically contain from 1 to 20 carbon atoms. Examples of “alkyl” as used herein include, but are not limited to, methyl, ethyl, n-propyl, n-butyl, n-pentyl, isobutyl, t-butyl, isopropyl, n-octyl, 2-octyl, n-heptyl, ethylhexyl, cyclopentyl, cyclohexyl, cycloheptyl, adamantyl, and norbornyl, and the like. Unless otherwise noted, alkyl groups may be mono- or polyvalent.

When a group is present more than once in a formula described herein, each group is “independently” selected unless specified otherwise.

In one embodiment, a pressure sensitive adhesive composition is described. The pressure sensitive adhesive comprises a (meth)acrylic polymer comprising epoxy-functional groups. The epoxy-functional (meth)acrylic polymer is combined with a triazine crosslinker to crosslink the epoxy-functional groups by means of the triazine crosslinker. In typical embodiments, the pressure sensitive adhesive is coated on a suitable substrate prior to crosslinking. The adhesive, in the absence of solvent, is pressure sensitive adhesive prior to and after crosslinking.

The pressure sensitive adhesive is typically organic solvent based or a hot melt adhesive. The pressure sensitive adhesive is generally non-aqueous and thus does not comprise water or a surfactant. Further, the pressure sensitive adhesive composition is not a syrup and thus comprises little or no polymerizable monomer.

The (meth)acrylic polymer is prepared from various monomers common to acrylic adhesives, such as a (meth)acrylic acid ester monomers (i.e. a (meth)acrylate ester monomer, also referred to as alkyl (meth)acrylate. At least one epoxy-functional ethylenically unsaturated monomer is included during the polymerization of the (meth)acrylic polymer. Thus, such (meth)acrylic polymer can be characterized as a (meth)acrylic copolymer. The (meth)acrylic copolymer optionally includes various other monomers.

The (meth)acrylic copolymer comprises one or more (meth)acrylate ester monomers derived from an (e.g. non-tertiary) alcohol containing from 1 to 22 carbon atoms. Examples of monomers include esters of either acrylic acid or methacrylic acid with a non-tertiary alcohol such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, citronellol, dihydrocitronellol and the like.

The pressure sensitive adhesive comprises one or more (meth)acrylic acid ester monomers having a low glass transition temperature (Tg) of no greater than 20° C. when reacted to form a homopolymer. Suitable low Tg monomers typically have a Tg no greater than 10° C., no greater than 0° C., no greater than −5° C., or no greater than −10° C. when such monomer reacted to form a homopolymer. The Tg of these homopolymers is often greater than or equal to −80° C., greater than or equal to −70° C., greater than or equal to −60° C., or greater than or equal to −50° C. The Tg of these homopolymers can be, for example, in the range of −80° C. to 20° C., −70° C. to 10° C., −60° C. to 0° C., or −60° C. to −10° C.

The low Tg alkyl acrylate monomer may have the following formula

H₂C═CR¹C(O)OR²

wherein R¹ is hydrogen or methyl and R² is alkyl or heteroalkyl with 1 to 22 carbons. The alkyl or heteroalkyl group can be linear, branched, cyclic, or a combination thereof.

Exemplary low Tg alkyl acrylates include for example ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 4-methyl-2-pentyl acrylate, n-octyl acrylate, isooctyl acrylate, 2-ethylhexyl acrylate, isononyl acrylate, decyl acrylate, isodecyl acrylate, lauryl acrylate, isotridecyl acrylate, octadecyl acrylate, and dodecyl acrylate.

Exemplary low Tg heteroalkyl acrylates include, but are not limited to, 2-methoxyethyl acrylate and 2-ethoxyethyl acrylate.

In some embodiments, the low Tg alkyl methacrylates include an alkyl group with greater than 4, 5, 6, 7 or 8 carbon atoms. Exemplary alkyl methacrylates include, but are not limited to, 2-ethylhexyl (meth)acrylate, isooctyl (meth)acrylate, n-octyl (meth)acrylate, isodecyl (meth)acrylate, and lauryl (meth)acrylate.

In some embodiments, the monomer is an ester of (meth)acrylic acid with an alcohol derived from a renewable source. A suitable technique for determining whether a material is derived from a renewable resource is through ¹⁴C analysis according to ASTM D6866-10, as described in US2012/0288692. The application of ASTM D6866-10 to derive a “bio-based content” is built on the same concepts as radiocarbon dating, but without use of the age equations. The analysis is performed by deriving a ratio of the amount of organic radiocarbon (¹⁴C) in an unknown sample to that of a modern reference standard. The ratio is reported as a percentage with the units “pMC” (percent modern carbon).

One suitable monomer derived from a renewable source is 2-octyl (meth)acrylate, as can be prepared by conventional techniques from 2-octanol and (meth)acryloyl derivatives such as esters, acids and acyl halides. The 2-octanol may be prepared by treatment of ricinoleic acid, derived from castor oil, (or ester or acyl halide thereof) with sodium hydroxide, followed by distillation from the co-product sebacic acid. Other (meth)acrylate ester monomers that can be renewable are those derived from ethanol and 2-methyl butanol.

In some embodiments, the (meth)acrylic copolymer may further comprise a high Tg alkyl (meth)acrylate monomer, having a Tg of at least 25° C., and preferably at least 50° C. Suitable high Tg monomers include, for example, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, benzyl methacrylate, 3,3,5 trimethylcyclohexyl acrylate, cyclohexyl acrylate, N-octyl acrylamide, and propyl methacrylate or combinations.

The Tg of the copolymer may be estimated by use of the Fox equation, based on the Tgs of the homopolymer of constituent monomers and the weight percent thereof.

In some embodiments, the (meth)acrylic copolymer comprises at least 50, 55, 60, 65, 70, 75, 80, 85, or 90 wt.-% up to 95, 96, 97, 98, or 99 wt.-% of low Tg (meth)acrylate ester monomers, based on the total weight of the (meth)acylic copolymer. When high Tg monomers are included, the (meth)acrylic polymer may include at least 5, 10, 15, 20, ranging up to 30 wt.-% of such high Tg monomer(s).

The (meth)acrylic copolymer comprises polymerized units derived from (meth)acryloyl epoxy-functional monomers.

An illustrative epoxy-functional (meth)acryloyl monomer is of the formula:

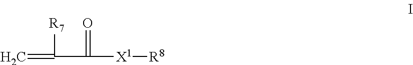

wherein:
R⁷ is —H or C₁-C₄ alkyl (e.g. methyl);
X¹ is —NR⁹— or —O—; and
R⁸ is an epoxy-substituted (hetero)hydrocarbyl group.

The R⁸ group is based on a straight-chain, branched, cyclic or polycyclic hydrocarbon of 2 to 30 carbons having an oxirane (epoxy) group. More preferably, the R⁸ group contains 3 or 4 to 10 carbons, such as glycidyl methacrylate (GMA), glycidyl acrylate (GA), and 4-hydroxylbutyl acrylate glycidylether (4-HBAGE). Some embodiments contain an epoxycyclohexyl group such as 3,4-epoxycyclohexylmethyl (meth)acrylate and 3-(2,3-epoxypropoxy)phenyl acrylate, 2-[4-(2,3-epoxypropoxy)phenyl]-2-(4-acryloyloxy-phenyl)propane, 4-(2,3-epoxypropoxy)cyclohexyl acrylate, 2,3-epoxycyclohexyl acrylate, and the acrylic acid monoester of poly(bisphenol-A diglycidyl ether), commercially available as Ebecryl™ 3605, from Cytec Industries., Woodland Park, N.J., and species having R⁸ according to the formula: —[(CH₂)₅C(O)O]ₙ—CH₂-epoxycyclohexyl, wherein n is 0 to 10 and preferably 1-4.

In one useful embodiment, the epoxy functional monomer is derived from the reaction of vinyldimethyl azlactone with a hydroxyalkyl epoxy compound as shown as follows:

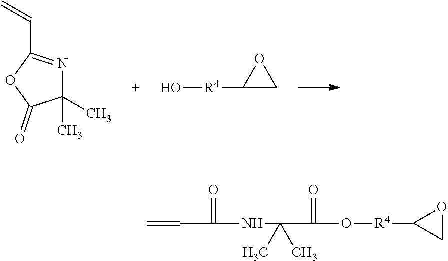

where R⁴ is a C₁-C₆ alkylene.

Some preferred epoxy monomers are of the formula:

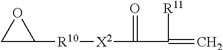

wherein:
R¹⁰ is a (hetero)hydrocarbyl group, preferably a hydrocarbyl group;
R¹¹ is —H or C₁-C₄ alkyl (e.g. methyl); and
X² is —NR¹²— or —O—.

One example of such epoxy monomer is oxiran-2-ylmethyl N-acryloyl-2-methylalaninate (EVDM).

In some embodiments, the (meth)acrylic copolymer comprised polymerized units of epoxy-functional ethylenically unsaturated monomer in an amount of at least 1, 1.5, 2, 2.5, 3, 3.5, 4, 4.5 or 5 wt.-% of the (meth)acrylic copolymer. The polymerized units of epoxy-functional ethylenically unsaturated monomer are typically present in an amount no greater than 10 wt.-% of the (meth)acrylic copolymer.

In some embodiments, the (meth)acrylic copolymer is substantially free of polymerized units derived from acid-functional ethylenically unsaturated monomer. Thus, the concentration of such polymerized units is less than 0.5 wt-%, less than 0.1 wt-% or zero of the (meth)acrylic copolymer. It has been found that a (meth)acrylic copolymer comprising epoxy-functional groups in the absence of acid-functional groups can be crosslinked with a triazine crosslinker. In some embodiments, the pressure sensitive adhesive comprises less than 0.5 wt-%, less than 0.1 wt-% or zero acid-functional groups.

One exemplary (meth)acrylic copolymer particularly suitable for a PSA is derived from copolymerizing isooctyl acrylate (IOA) and 4-hydroxylbutyl acrylate glycidylether (4-HBAGE).

In some embodiments, the (meth)acrylic copolymer comprises polymerized units derived from an acid-functional ethylenically unsaturated monomer, where the acid-functional group may be an acid per se, such as a carboxylic acid, or a portion may be salt thereof, such as an alkali metal carboxylate. Useful acid-functional ethylenically unsaturated monomers include, but are not limited to, those selected from an ethylenically unsaturated carboxylic acid, ethylenically unsaturated sulfonic acid, ethylenically unsaturated phosphonic acid, and mixtures thereof. Examples of such compounds include those selected from acrylic acid (AA), methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinylphosphonic acid, and mixtures thereof.

Acid-functional ethylenically unsaturated monomers are typically selected from ethylenically unsaturated carboxylic acids, i.e., (meth)acrylic acids. When an even stronger acid is desired, an acid-functional ethylenically unsaturated monomer includes an ethylenically unsaturated sulfonic acid, an ethylenically unsaturated phosphonic acid, or a mixture thereof.

In some embodiments, the (meth)acrylic copolymer comprises polymerized units of acid-functional ethylenically unsaturated monomer in an amount of at least 1, 1.5, 2, 2.5, 3, 3.5, 4, 4.5 or 5 wt.-% of the (meth)acrylic copolymer. The polymerized units of acid-functional ethylenically unsaturated monomer are typically present in an amount no greater than 15, 14, 13, 12, or 10 wt.-% of the (meth)acrylic copolymer.

One (meth)acrylic copolymer suitable for a PSA that comprises both carboxylic acid and epoxy functionality, is derived from copolymerizing isooctyl acrylate (IOA), acrylic acid (AA), and 4-hydroxylbutyl acrylate glycidylether (4-HBAGE). Other (meth)acrylic copolymers that comprise both carboxylic acid and epoxy functionality, are derived from copolymerizing isooctyl acrylate (IOA), acrylic acid (AA), and glycidyl methacrylate (GMA) or glycidyl acrylate (GA) or oxiran-2-ylmethyl N-acryloyl-2-methylalaninate (EVDM).

The (meth)acrylic copolymer may optionally comprise other monomers such as a non-acid-functional polar monomer. Representative examples of a suitable non-acid-functional polar monomer includes, but is not limited, to 2-hydroxyethyl (meth)acrylate; N-vinylpyrrolidone; N-vinylcaprolactam; acrylamide; mono- or di-N-alkyl substituted acrylamides such as t-butyl acrylamide, dimethylaminoethyl acrylamide, and N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates and mixtures thereof.

The (meth)acrylic copolymer may comprise 1 to 10 wt.-% of polymerized units of a non-acid-functional polar monomer. In some embodiments, the (meth)acrylic copolymer comprises less than 0.5 wt.-%, less than 0.1 wt. % or zero polymerized units of a non-acid-functional polar monomer.

The (meth)acrylic copolymer may optionally comprise a vinyl monomer such as styrene, substituted styrene (e.g., α-methyl styrene), vinyl halide, and mixtures thereof. As used herein, the term “vinyl monomer” is exclusive of an acid-functional ethylenically unsaturated monomer, an acrylate ester monomer, and a non-acid polar monomer. The (meth)acrylic copolymer may comprise 1 to 10 wt.-% of polymerized units of a vinyl monomer. In some embodiments, the (meth)acrylic copolymer comprises less than 0.5 wt.-%, less than 0.1 wt. % or zero polymerized units of a vinyl monomer.

A multifunctional (meth)acrylate monomer may optionally be incorporated into the blend of monomers during the polymerization of the (meth)acrylic copolymer. Examples of useful multifunctional (meth)acrylates include, but are not limited to, di(meth)acrylates, tri(meth)acrylates, and tetra(meth)acrylates, such as 1,6-hexanediol di(meth)acrylate (HDDA), poly(ethylene glycol) di(meth)acrylates, polybutadiene di(meth)acrylate, polyurethane di(meth)acrylates, and propoxylated glycerin tri(meth)acrylate, and mixtures thereof. The (meth)acrylic copolymer may include at least 0.01, 0.02, 0.03, 0.04, or 0.05 up to 1, 2, 3, 4, or 5 wt.-% of polymerized units of a multifunctional (meth)acrylate. In some embodiments, the concentration of such polymerized units is less than 0.005 wt.-% or zero of the (meth)acrylic copolymer.

The (meth)acrylic copolymer comprising epoxy-functional groups is combined with a (e.g. chlorinated) triazine crosslinking agent.

Various (e.g. chlorinated) triazine crosslinking agents are known. In one embodiment, the crosslinking agent is as described in U.S. Pat. No. 4,330,590 (Vesley), and is of the formula:

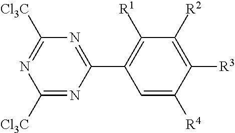

wherein: R¹, R², R³, and R⁴ are independently hydrogen, alkyl, or alkoxy; and 1-3 of the R¹, R², R³, and R⁴ groups are hydrogen. Preferably, the alkyl and alkoxy groups have no more than 12 carbon atoms, and often no more than 4 carbon atoms. Preferably, both R² and R³ are alkoxy, because this tends to provide shorter reaction times. Adjacent alkoxy substituents may be interconnected to form a ring. The photoactive s-triazine component may be prepared by the co-trimerization of an aryl nitrile with trichloroacetonitrile in the presence of HCl gas and a Lewis acid such as AlCl₃, AlBr₃, etc., as described in Bull. Chem. Soc. Japan, Vol. 42, page 2924 (1969).

In another embodiment, the crosslinking agent is as described in U.S. Pat. No. 4,329,384 (Vesley), and is of the formula:

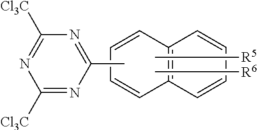

wherein: R⁵ and R⁶ are independently hydrogen, alkyl, or alkoxy. By this representation, it is meant that R⁵ and R⁶ can be on either of the fused rings. Preferably, any alkyl or alkoxy group of the photoactive s-triazine component has no more than 12 carbon atoms, and no more than two alkyl and alkoxy groups have more than 6 carbon atoms. In certain embodiments, they have no more than 4 carbon atoms, and the alkyl is often methyl or ethyl, and the alkoxy is often methoxy or ethoxy. Adjacent alkoxy substituents may be interconnected to form a ring. The photoactive s-triazine component may be prepared by the co-trimerization of a polynuclear nitrile with trichloroacetonitrile in the presence of HCl gas and a Lewis acid such as AlCl₃, AlBr₃, etc. as described in Bull. Chem. Soc. Jap., Vol. 42, pages 2924-2930 (1969).

Examples of suitable chlorinated triazine crosslinking agents include, but are not limited to, 2,4-bis(trichloromethyl)-6-(4-methoxy)phenyl)-s-triazine; 2,4-bis(trichloromethyl)-6-(3,4-dimethoxy)phenyl)-s-triazine; 2,4-bis(trichloromethyl)-6-(3,4,5-trimethoxy)phenyl)-s-triazine; 2,4-bis(trichloromethyl)-6-(2,4-dimethoxy)phenyl)-s-triazine; 2,4-bis(trichloromethyl)-6-(3-methoxy)phenyl)-s-triazine as described in U.S. Pat. No. 4,330,590 (Vesley), and 2,4-bis(trichloromethyl)-6-naphthenyl-s-triazine and 2,4-bis(trichloromethyl)-6-(4-methoxy)naphthenyl-s-triazine as described in U.S. Pat. No. 4,329,384 (Vesley).

The chlorinated triazine crosslinking agent is preferably a photo-crosslinking agent. More preferably, the triazine crosslinking agent is a chromophore-substituted chloro-methyl-s-triazine crosslinking agent, which can be prepared according to Wakabayashi et al., Bull. Chem. Soc. Jap., Vol. 42, pages 2924-2930 (1969).

The chlorinated triazine crosslinking agent is present in an amount of at least 0.001, 0.002, 0.003, 0.004, or 0.005 based on the total weight of the epoxy-functional (meth)acrylic copolymer. In some embodiments, the chlorinated triazine crosslinking agent is present in an amount of at least 0.05, 0.06, 0.07, 0.08, 0.09, or 0.10 wt.-% based on the total weight of the epoxy-functional (meth)acrylic copolymer. In typical embodiments, the concentration of chlorinated triazine crosslinking agent is no greater than 1 wt-%. In some embodiments, the concentration of chlorinated triazine crosslinking agent is no greater than 0.9, 0.8, 0.7, 0.6, or 0.5 wt-%. When the pressure sensitive adhesive is free of tackifier, very low concentrations of chlorinated triazine crosslinking agent can improve the (e.g. room temperature) shear strength properties. Higher concentrations are typically used when tackifier is present.

The inclusion of chlorinated triazine crosslinking agent generally improves at least the room temperature shear strength to stainless steel. In some embodiments, the inclusion of the chlorinated triazine crosslinking agent improves the 70° C. shear strength to stainless steel, especially for pressure sensitive adhesive compositions comprising tackifier. The shear strength values to stainless steel often exceed 10000 minutes. The peel adhesion values can vary. In some embodiments, the 180 angle degree peel adhesion to glass is at least 10, 15, or 20 N/dm. In some embodiments, the 180 angle degree peel adhesion to glass is no greater than about 100 or 150 N/dm. The gel content typically increases at least 2 or 3 percent by inclusion of the chlorinated triazine crosslinking agent. The increase in gel content can be at least 5, 10, 15, 20, or 25% for the pressure sensitive adhesive compositions comprising tackifier. The shear strength and peel adhesion values as well as gel content are determined according to the test methods described in the forthcoming examples.

Although the epoxy functional groups of the (meth)acrylic copolymer can be crosslinked with the triazine crosslinking agent in the absence of an (oxonium salt) ionic photoacid generator, an ionic photoacid generator can optionally be included. A more detailed explanation of the reaction scheme when an ionic photoacid generator is present is described in WO 2012/177337, incorporated herein by reference. Upon irradiation with light energy, such ionic photoacid generators undergo a fragmentation reaction and release one or more molecules of Lewis or Brønsted acid that catalyze the ring opening and addition of the pendent epoxy groups to form a crosslink. Useful photoacid generators are thermally stable and do not undergo thermally induced reactions with the copolymer, and are readily dissolved or dispersed in the crosslinkable composition. Some common nonnucleophilic anions that may indicate the presence of an ionic photoacid generator include SbF₆⁻, AsF₆⁻, PF₆⁻, BF₄⁻, and B(C₆F₅)₄⁻. However, in typical embodiments, the (meth)acrylic copolymer (e.g. adhesive) composition is substantially free of (oxonium salt) ionic photoacid generator. Thus, the concentration of such is less than 0.01 or 0.005 wt.-% or zero of the (meth)acrylic polymer and adhesive composition.

Although a (meth)acrylic copolymer comprising pendent (e.g. carboxylic) acid functionality can be crosslinked with certain epoxy resins that on average comprise greater than 1 (e.g. 1.5 or 2) polymerizable epoxy groups per molecule, in typical embodiments, the (meth)acrylic copolymer (e.g. adhesive) composition is substantially free of polymerized units derived from such epoxy resin. Thus, the concentration of such polymerized units is less than 0.1 or 0.05 wt.-% or zero of the pressure sensitive adhesive.

The (meth)acrylic copolymer comprising polymerized units comprising pendent epoxy-functional groups optionally in combination with pendent (e.g. carboxylic) acid-functional groups is typically prepared by copolymerizing the alkyl (meth)acrylate monomer(s), the monomer comprising an epoxy-functional group, and optional other monomers such as ethylenically unsaturated monomer comprising an acid-functional group. The method of forming the epoxy-functional (meth)acrylic copolymer is typically a solution polymerization or a bulk polymerization.

In one embodiment, the epoxy-functional (meth)acrylic copolymer is a thermoplastic or thermosettable hot melt processable composition. Such compositions can be prepared by a method described in U.S. Pat. No. 5,804,610, incorporated herein by reference. One embodied method comprises (a) providing a pre-adhesive (e.g. syrup) composition which upon exposure to transmissive energy polymerizes to provide a thermoplastic or thermosettable hot melt adhesive; (b) substantially surrounding the pre-adhesive composition with a packaging material; (c) exposing the pre-adhesive composition to transmissive energy (e.g. actinic radiation) capable of polymerizing said pre-adhesive composition; and (d) allowing polymerization of the pre-adhesive composition to occur to provide said thermoplastic or thermosettable hot melt adhesive. The packaging material is selected such that it does not substantially adversely affect the desired adhesive properties of the hot melt adhesive composition when the hot melt adhesive composition and the packaging material are melted and mixed together.

The pre-adhesive composition may be a monomeric mixture of the (meth)acrylic monomer(s) and epoxy functional ethylenically monomer(s) or a prepolymeric mixture thereof. The prepolymeric mixture may be a syrup formed by the partial polymerization of the monomeric materials. Since the triazine crosslinking agent is not present during the free-radical polymerization of the (meth)acrylic monomer(s) and epoxy functional ethylenically unsaturated monomer(s), the epoxy functional groups remain unreacted.

The packaging material preferably melts at or below the processing temperature of the adhesive (i.e., the temperature at which the adhesive flows). The packaging material preferably has a melting point of 200° C. or 175° C. or less. In one embodiment the melting point ranges from 90° C. to 150° C. The packaging material may be a flexible thermoplastic polymeric film such as ethylene-vinyl acetate, ethylene-acrylic acid, polypropylene, polyethylene, polybutadiene, or ionomeric films. The films thickness is typically at least 0.01 or 0.025 mm and no greater than 0.25, 0.20, 0.15, or 0.10 mm.

The amount of packaging material can be at at least 0.5, 1, 2, or 3 wt.-% of the (meth)acrylic copolymer or hot melt adhesive composition and is typically no greater than 10, or 5 wt-%. The packaging material should be appropriate for the polymerization method used. For example, with photopolymerization, it is necessary to use a film material that is sufficiently transparent to ultraviolet radiation at the wavelengths necessary to effect polymerization.

A small amount of volatile, non-polymerizable organic solvent may be included in the pre-adhesive composition to dissolve other additives, such as a crosslinking agent. The pre-adhesive composition preferably contains less than 10, 5, 4, 3, 2, or 1 weight percent of solvent. Likewise, the pressure sensitive adhesive before and after crosslinking generally comprises less than 5, 4, 3, 2, 1, or 0.5 wt-% of non-polymerizable organic solvent.

Polymerization of the (meth)acrylic monomer(s) and epoxy functional ethylenically unsaturated monomer(s) can be accomplished by exposing the pre-adhesive (e.g. syrup) composition to energy in the presence of a photoinitiator. Energy activated initiators may be unnecessary where, for example, ionizing radiation is used to initiate polymerization. Typically, a photoinitiator can be employed in a concentration of no more than 3, 2, 1 or 0.5 parts by weight, based on the total weight of the (meth)acrylic copolymer.

Useful photoinitiators include benzoin ethers such as benzoin methyl ether and benzoin isopropyl ether; substituted acetophenones such as 2,2-dimethoxy-2-phenylacetophenone photoinitiator, available under the trade name IRGACURE 651 or ESACURE KB-1 photoinitiator (Sartomer Co., West Chester, Pa.), and dimethylhydroxyacetophenone; substituted α-ketols such as 2-methyl-2-hydroxy propiophenone; aromatic sulfonyl chlorides such as 2-naphthalene-sulfonyl chloride; and photoactive oximes such as 1-phenyl-1,2-propanedione-2-(O-ethoxy-carbonyl)oxime. Particularly preferred among these are the substituted acetophenones.

Preferred photoinitiators are photoactive compounds that undergo a Norrish I cleavage to generate free radicals that can initiate by addition to the acrylic double bonds. The photoinitiator can be added to the mixture to be coated after the copolymer has been formed, i.e., photoinitiator can be added to the syrup composition. Such polymerizable photoinitiators are described, for example, in U.S. Pat. Nos. 5,902,836 and 5,506,279 (Gaddam et al.).

The composition and the photoinitiator may be irradiated with activating UV radiation to polymerize the monomer component(s). UV light sources can be of two types: 1) relatively low light intensity sources such as blacklights and light emitting diodes (LEDs), which provide generally 10 mW/cm² or less (as measured in accordance with procedures approved by the United States National Institute of Standards and Technology as, for example, with a UVIMAP UM 365 L-S radiometer manufactured by Electronic Instrumentation & Technology, Inc., in Sterling, Va.) over a wavelength range of 280 to 400 nanometers; and 2) relatively high light intensity sources such as medium pressure mercury lamps which provide intensities generally greater than 10 mW/cm², preferably 15 to 450 mW/cm². High intensities and short exposure times are typically preferred. For example, an intensity of 600 mW/cm² and an exposure time of about 1 second may be used successfully. Intensities can range from 0.1 to 150 mW/cm², preferably from 0.5 to 100 mW/cm², and more preferably from 0.5 to 50 mW/cm². Such photoinitiators are typically present in an amount of from 0.1 to 1.0 wt. % of the (meth)acrylic copolymer. Accordingly, relatively thick coatings can be achieved when the extinction coefficient of the photoinitiator is low.

When preparing (meth)acrylic copolymers described herein, the photoinitiated polymerization reactions proceed to virtual completion, i.e., depletion of the monomeric components. Thus, after exposing the pre-adhesive composition to transmissive energy (e.g. actinic radiation) the epoxy-functional (meth)acrylic copolymer composition typically contains less than 5, 4, 3, 2, 1, or 0.5 wt. % of polymerizable monomer.

The (meth)acrylic copolymer has a weight average molecular weight of at least 50,000, 100,000 or 200,000 g/mole and is typically no greater than 3,000,000 or 2,000,000 or 1,500,000 g/mole.

The (meth)acrylic copolymer or adhesive typically has a storage modulus (G′) at 25° C. and a frequency of 1 radian/second of at least 1×10⁴ dynes/cm² and no greater than 1×10⁸ or 1×10⁷ or 1×10⁶ dynes/cm² as determined by means of a Dynamic Mechanical Analyzer. For example, the storage modulus of a (meth)acrylic copolymer prepared from 90 parts isooctyl acrylate, 10 parts acrylic acid, and a minor amount of epoxy-functional monomer is about 1.5×10⁶ dynes/cm². In yet another example, a (meth)acrylic copolymer prepared from 98 parts isooctyl acrylate and 2 parts acrylic acid and a minor amount of epoxy-functional monomer is about 2×10⁵ dynes/cm². When the (meth)acrylic polymer alone is not a PSA, the composition further comprises a tackifying resin to reduce the storage modulus.

The triazine crosslinker is combined with the epoxy functional (meth)acrylic copolymer after the (meth)acrylic copolymer is formed, but prior to the pressure sensitive adhesive being applied to a substrate. In one embodiment, a solidified hot melt adhesive contained by packaging material as previously described may comprise the triazine crosslinker (added after the polymerization of the (meth)acrylic copolymer). In another embodiment, an organic solvent-based pressure sensitive adhesive may comprise the triazine crosslinker. In other embodiments, the triazine crosslinker is added to the solvent-based on hot melt pressure sensitive adhesive at the time of coating. For example, a triazine crosslinker may be added to the pressure sensitive adhesive after melting the hot melt adhesive together with the packaging material.

The (e.g. pressure-sensitive) adhesive composition may contain one or more conventional additives. Such additives are typically combined with the (meth)acrylic copolymer after the copolymer is formed. Preferred additives include tackifiers, plasticizers, fillers (e.g. glass or polymeric bubbles, beads, or fibers, fumed silica), dyes, antioxidants, UV stabilizers, and fire retardants.

In some embodiments, the pressure sensitive adhesive further comprises tackifying resin. Suitable tackifying resins include rosin esters, terpenes, phenols, and aliphatic, aromatic, or mixtures of aliphatic and aromatic synthetic hydrocarbon monomer resins. Examples of useful tackifying resins that are commercially available include Foral™85 and hydrocarbon resins sold under the Regalrez™ tradename by Hercules, Inc., and the trade designation ECR-180 available from Exxon Chemicals. When present, the amount of tackifying resin is typically at least 1, 2, 3, 4, or 5 wt-% of the pressure sensitive adhesive and no greater than about 50 or 40 wt-% of the pressure sensitive adhesive. In some embodiments, the amount of tackifying resin is at least 10, 15 or 20 wt-% of the pressure sensitive adhesive. In other embodiments, the amount of tackifying resin is less than 1 wt.-% or 0.5 wt.-% or zero.

The method of preparing a pressure sensitive adhesive composition generally comprises providing a non-aqueous pressure sensitive adhesive such as an organic solvent based or hot melt adhesive, wherein the adhesive comprises a (meth)acrylic copolymer comprising epoxy-functional groups. The method further comprises adding a chlorinated triazine crosslinker to the pressure sensitive adhesive or in other words combining the pressures sensitive adhesive with the chlorinated triazine crosslinker and coating the pressure sensitive adhesive onto a substrate.

The hot melt adhesives are generally solid at 25° C. and heated to melt the hot melt adhesive in order to coat the hot melt adhesive on a substrate using conventional hot melt coating techniques modified as appropriate to the particular substrate. In typical embodiments, the hot melt adhesive compositions have a viscosity ranging from 10 to 10000 Pa·s at a temperature ranging from 130° C. to 180° C. at a shear rate ranging from 0.1 to 1000 (1/s). The heating can be accomplished with conventional equipment such as an extruder, bulk tank melter, melt-on-demand equipment, or a hand-held hot melt adhesive gun. For example, these compositions can be applied to a variety of solid substrates by (e.g. melt-blown) spray coating, knife coating, and die coating.

The organic solvent-based adhesive may comprise 10, 15, 20, 25, 30, or 35 wt-% to 50 wt-% of the pressures sensitive adhesive dissolved in organic solvent. The solvent based adhesives may be applied by methods such as roller coating, spray coating, flow coating, dip coating, spin coating, etc.

These various methods of coating allow the compositions to be placed on the substrate at variable thicknesses thus allowing a wider range of use of the compositions. The thickness of the PSA layer is typically at least about 25 microns (about 1 mil) and no greater than 1500 microns (60 mil), 1000 microns (40 mils), or 500 microns (20 mils).

The epoxy functional (meth)acrylic copolymer pressure sensitive adhesive composition comprising the triazine crosslinking agent can be coated upon suitable substrates, such as a release liner or (e.g. flexible and inflexible) backing material, by conventional coating techniques, then crosslinked, to produce adhesive coated sheet materials.

The adhesive can also be provided in the form of a pressure-sensitive adhesive transfer tape in which at least one layer of the adhesive is disposed on a release liner for application to a permanent (e.g. second) substrate at a later time. The adhesive can also be provided as a single coated or double coated tape in which the adhesive is disposed on a permanent backing.

The flexible backing material may be any material conventionally utilized as a tape backing, optical film, or any other flexible material.

Examples of materials that can be included in the flexible backing include polyolefins such as polyethylene, polypropylene (including isotactic polypropylene), polystyrene, polyvinyl alcohol, poly(ethylene terephthalate), poly(butylene terephthalate), poly(caprolactam), poly(vinylidene fluoride), polylactides, cellulose acetate, and ethyl cellulose and the like.

Commercially available backing materials include for example HOSTAPHAN 3SAB, primed polyester film (available from Mitsubishi Polyester Film Inc., Greer, S.C.), Kraft paper (available from Monadnock Paper, Inc.); cellophane (available from Flexel Corp.); spun-bond poly(ethylene) and poly(propylene), such as TYVEK and TYPAR (available from DuPont, Inc.); and porous films obtained from poly(ethylene) and poly(propylene), such as TESLIN (available from PPG Industries, Inc.), and CELLGUARD (available from Hoechst-Celanese).

Backings may also be prepared of fabric such as woven fabric formed of threads of synthetic or natural materials such as cotton, nylon, rayon, glass, ceramic materials, and the like or nonwoven fabric such as air laid webs of natural or synthetic fibers or blends of these. The backing may also be formed of metal, metalized polymer films, or ceramic sheet materials that may take the form of any article conventionally known to be utilized with pressure-sensitive adhesive compositions such as labels, tapes, signs, covers, marking indicia, and the like.

The flexible support may also include a release-coated substrate. Such substrates are typically employed when an adhesive transfer tape is provided. Examples of release-coated substrates are well known in the art and include, by way of example, silicone-coated Kraft paper, and the like. Tapes of the disclosure may also incorporate a low adhesion backsize (LAB), which are known in the art.

Objects and advantages of this disclosure are further illustrated by the following examples, but the particular materials and amounts thereof recited in these examples, as well as other conditions and details, should not be construed to unduly limit this disclosure.

As used herein, “pph” refers to parts per one hundred parts of the monomers of the epoxy-functional (meth)acrylic copolymer.

### Test Methods

Peel Adhesion was measured at an angle of 180 degrees 23° C. (73° F.) and 50% relative humidity (RH) as described in ASTM D3330/D3330M-04 (Reapproved 2010): “Standard Test Method for Peel Adhesion of Pressure-Sensitive Tape”. After conditioning for 24 hours at 23° C. (73° F.) and 50% relative humidity (RH) tape samples measuring 12.7-millimeters (0.50 inches) wide and 20.3 centimeters (8 inches) long were cut. The tape samples were then applied to a glass plate previously wiped clean with methyl ethyl ketone (MEK), then n-heptane, and again with MEK. The tape sample was rolled down twice in each direction using a 2 kilogram (4.4 pound) rubber roller. Peel adhesion was measured at a platen speed of 305 millimeters/minute (12 inches/minute) over a length of 5.1 centimeters (2 inches) using an IMASS Slip/Peel Tester (Model SP-2000, available from IMASS Incorporated, Accord, Mass.). Three samples were evaluated, the results normalized to Newtons/decimeter (N/dm), and the average reported.

### Shear Strength at Room Temperature

Shear strength at 23° C. (73° F.) and 50% relative humidity (RH) was measured as described in ASTM D3654/D 3654M-06: “Standard Test Methods for Shear Adhesion of Pressure-Sensitive Tapes” (Reapproved 2011). After conditioning for 24 hours at 23° C. (73° F.) and 50% relative humidity (RH) tape samples measuring 12.7-millimeters (0.50 inches) wide and 15.2 centimeters (6 inches) long were cut. The tape samples were then applied to a stainless steel panel previously wiped clean with methyl ethyl ketone (MEK), then n-heptane, and again with MEK. The samples were then centered on the panels and adhered to one end such that tape overlapped the panel by 25.4 millimeters (1 inch) in the lengthwise direction and rolled down twice in each direction using a 2 kilogram (4.4 pound) rubber roller.

A 1.0 kilogram (2.2 pound) weight was then attached to the free end of the tape, and the panel/tape/weight assembly was suspended in a stand at an angle of 2° from vertical. The time, in minutes, for the tape to fall from the panel was recorded along with the mode of failure. Two different failure modes were observed: 1) cohesive (c) in which the adhesive split and part was left on the tape and part left on the tape backing; and 2) pop-off (p) in which the adhesive tape was cleanly delaminated from the panel. The test was terminated if failure had not occurred in 10,000 minutes and the result recorded as “10000”. The average of three samples was reported.

### Shear Strength at 70° C. (158° F.)

Shear strength at 70° C. (158° F.) was evaluated in the same manner as described for room temperature testing with the following modifications. A weight of 0.5 kilograms (1.1 pounds) was used and the panel/tape/weight assembly was suspended an angle of 2° from vertical in a stand that was in an oven set at 70° C. (158° F.).

### Percent Gel

The percent gel was measured as follows. A round test specimen having a diameter of 32 millimeters (1.26 inches) was die-cut from a tape sample and placed in a mesh basket measuring 40 millimeters (1.57 inches) square. The basket with the specimen was weighed to the nearest 0.1 milligram then put into a capped jar containing sufficient toluene to cover the specimen. After 24 hours the basket/specimen was removed, drained, and placed in an oven at 130° C. (266° F.) for 30 minutes. The weight percent gel was determined using the final, dried specimen weight and the original specimen weight, after subtracting the weight of a corresponding uncoated sample of the polyester film backing from each, as shown in the equation below:

$$Percent Gel = \frac{( Final Dried specimen wt . - uncoated backing wt . )}{( Original specimen wt . - uncoated backing wt . )} \times 100$$

### Materials

| Designation | Description |
|---|---|
| IOA | Isooctyl acrylate. |
| AA | Acrylic acid, Sigma Aldrich, St. Louis, MO |
| IBOA | Isobornyl acrylate, having a homopolymeric |
| | glass transition temperature (Tg) of 98° C., |
| | available from San Esters Corporation, New |
| | York, NY. |
| Triazine | 2,6-bis-trichoromethyl-4-(3,4- |
| | dimethoxyphenyl)-s-triazine, a photoactive |
| | crosslinking agent. |
| 4-HBAGE | 4-hydroxybutyl acrylate glycidylether, |
| | having a homopolymeric glass transition |
| | temperature (Tg) of −64° C., Nippon Kasei |
| | Chemical Company, LTD., Tokyo, Japan. |
| AMBN | 2,2′azobis-(2-methylbutyronitrile), a |
| | thermal initiator for free radical |
| | polymerization, available under the trade |
| | designation VAZO 67 from E.I. du Pont de |
| | Nemours and Company, Wilmington, DE. |
| F85-E | A tackifier resin based on a thermoplastic |
| | ester resin derived from glycerol and a |
| | highly stabilized rosin, with a softening |
| | point of between 80 and 88° C. (Hercules |
| | Drop Method), available under the trade |
| | designation FORAL 85-E Ester of |
| | Hydrogenated Rosin, available from |
| | Eastman Chemical Co., Kingsport, TN. |
| PET Film | A primed polyester film, having thickness of |
| | 50 micrometers (0.002 inches), available |
| | under the trade designation HOSTAPHAN |
| | 3SAB, available from Mitsubishi Polyester |
| | Film, Incorporated, Greer, SC. |

As used herein, “pph” refers to parts per one hundred parts of the copolymerized acrylic monomers, e.g., 100 parts of IOA,-AA, and 4-HBAGE total.

### Preparation of Base Pressure Sensitive Adhesive (PSA) Polymer Solutions A-E

Solutions of base pressure sensitive adhesive copolymers A-E were prepared by thermally initiated free radical polymerization of the monomers as shown. The monomers, 0.2 wt % AMBN, and ethyl acetate were added to a 0.95 liter (1 quart) amber bottle, the solution purged for 15 minutes with nitrogen, and the bottle tightly capped shut and placed in a rotating laundrometer at 60° C. (140° F.) for 16 hours. The bottles were then allowed to cool to room temperature and the resulting polymer solutions, ca. 33 wt % solids, used to prepare the examples listed further below.

TABLE 1
Composition of Base PSA Copolymers A-E

| Base PSA | IOA | AA | IBOA | 4-HBAGE |
|---|---|---|---|---|
| Polymer | parts by weight | | | |
| A | 95 | 5 | 0 | 0 |
| B | 90.25 | 4.75 | 0 | 5 |
| C | 80 | 0 | 20 | 0 |
| D | 76 | 0 | 19 | 5 |
| E | 80 | 0 | 15 | 5 |

### Comparative Examples C1 to C13

Triazine crosslinker and F85-E tackifier were added in various amounts to Base PSA Polymer Solution A and dissolved to give coating solutions. The amounts of Triazine and tackifier are shown in Table 2 below. These solutions were coated using a notch-bar over bed coater onto PET Film at a wet thickness of 200 micrometers (0.0079 inches) and dried for 30 minutes in an oven at 70° C. (158° F.) as measured by a thermocouple. The resulting dried samples were exposed to UV-A irradiation from a high intensity mercury lamp having a type D bulb (available under the trade designation LIGHT HAMMER 10, equipped with D Bulb BT13D, and set at its' maximum power output of 600 Watts/inch, from Heraeus Noblelight Fusion UV Incorporated, Gaithersburg, Md.) located approximately 53 millimeters from the sample to provide an approximate total energy of 500 milliJoules/square centimeter. The web speed was 27.4 meters/minute (90 feet/minute). The total energy was determined using a radiometer (available under the trade designation UV Power Puck II from EIT Instrument Markets, Sterling, Va.) at the same web speed. The final polymer thickness on the pressure sensitive tapes obtained was approximately 50 micrometers (0.002 inches). Test results are shown in Table 2 below.

TABLE 2
Final PSA Compositions Made from Base PSA Copolymer A and Results

| | | | RT | 70° C. | 180° | |
|---|---|---|---|---|---|---|
| | | | Shear | Shear | Peel | |
| Comparative | Triazine | F85 | SS | SS | Glass | |
| Example | (pph) | (pph) | (min.) | (min.) | (N/dm) | % Gel |
| C1 | 0 | 0 | 4 c | 1 c | 60 | 0 |
| C2 | 0.05 | 0 | 10000 | 10000 | 50 | 78 |
| C3 | 0.05 | 20 | 369 c | 22 c | 126 c | 30 |
| C4 | 0.05 | 40 | 115 c | 1 c | 148 c | 5 |
| C5 | 0.1 | 0 | 10000 | 10000 | 45 | 87 |
| C6 | 0.1 | 20 | 796 c | 258 c | 118 c | 29 |
| C7 | 0.1 | 40 | 154 c | 1 c | 141 c | 5 |
| C8 | 0.2 | 0 | 3776 p | 10000 | 32 | 88 |
| C9 | 0.2 | 20 | 4150 c | 579 c | 108 c | 40 |
| C10 | 0.2 | 40 | 197 c | 1 c | 138 c | 5 |
| C11 | 0.4 | 0 | 1096 p | 10000 | 26 | 90 |
| C12 | 0.4 | 20 | 133 c | 1 c | 106 c | 36 |
| C13 | 0.4 | 40 | 181 c | 1 c | 123 c | 14 |

(c) cohesive
(p) pop off

### Examples 1 to 15

Examples 1-15 were prepared as described above for Comparative Examples 1-13 with the following modification. Base PSA Polymer Solution B was used in place of Base PSA Polymer Solution A. The amounts of Triazine and tackifer, and tape test results are shown in Table 3 below.

TABLE 3
Final PSA Compositions Made from Base PSA Copolymer B and Results

| | | | RT | 70° C. | 180° | |
|---|---|---|---|---|---|---|
| | | | Shear | Shear | Peel | |
| | Triazine | F85 | SS | SS | Glass | |
| Example | (pph) | (pph) | (min.) | (min.) | (N/dm) | % Gel |
| 1 | 0 | 0 | 50 c | 366 c | 51 | 39 |
| 2 | 0.05 | 0 | 10000 | 10000 | 39 | 82 |
| 3 | 0.05 | 20 | 10000 | 10000 | 118 c | 37 |
| 4 | 0.05 | 40 | 725 c | 188 c | 137 c | 17 |
| 5 | 0.1 | 0 | 10000 | 10000 | 31 | 90 |
| 6 | 0.1 | 20 | 10000 | 10000 | 112 c | 44 |
| 7 | 0.1 | 40 | 10000 | 10000 | 139 c | 23 |
| 8 | 0.2 | 0 | 10000 | 10000 | 25 | 91 |
| 9 | 0.2 | 20 | 10000 | 10000 | 114 c | 42 |
| 10 | 0.2 | 40 | 10000 | 10000 | 140 c | 27 |
| 11 | 0.4 | 0 | 10000 | 10000 | 20 | 89 |
| 12 | 0.4 | 20 | 10000 | 10000 | 108 c | 48 |
| 13 | 0.4 | 40 | 10000 | 10000 | 146 c | 26 |
| 14 | 0.005 | 0 | N.T. | 10000 | 61 | N.T. |
| 15 | 0.005 | 20 | N.T. | 2 | 87 c | N.T. |

(c) cohesive
N.T.: not tested

### Comparative Examples 14 and 15 and Examples 16 to 19

Comparative Examples 14 and 15 and Examples 16-19 were prepared as described above for Comparative Examples 1-13 and Examples 1-15 respectively with the following modifications. For Comparative Examples 14 and 15 Base PSA Polymer Solution C was used in place of Base PSA Polymer Solution A. For Examples 16-19 Base PSA Polymer Solutions D and E were used in place of Base PSA Polymer Solution B. These changes resulted in IBOA being used in place of AA. In addition, no tackifier was used. The amounts of Triazine and tape test results are shown in Table 4 below.

TABLE 4
Final PSA Compositions Made from Base PSA Copolymers
C-E and Results

| Examples | | | 70° C. | 180° |
|---|---|---|---|---|
| and | | | Shear | Peel |
| Comparative | Base | Triazine | SS | Glass |
| Examples | Polymer | (pph) | (min) | (N/dm) |
| C14 | C | 0.01 | 1 | 99 c |
| C15 | C | 0.05 | 4 | 122 c |
| 16 | D | 0.01 | 1 | 111 c |
| 17 | D | 0.05 | 23 | 118 c |
| 18 | E | 0.1 | 10000 | 32 |
| 19 | E | 0.2 | 10000 | 25 |

(c)—cohesive

1. A method of preparing a pressure sensitive adhesive composition comprising:
a) providing a non-aqueous pressure sensitive adhesive comprising no greater than 5 wt-% polymerizable monomer and a (meth)acrylic copolymer comprising epoxy-functional groups;
b) adding a chlorinated triazine crosslinker to the pressure sensitive adhesive; and
c) coating the pressure sensitive adhesive onto a substrate.

2. The method of claim 1 further comprising contacting the pressure sensitive adhesive to at least one second substrate.

3. The method of claim 1 further comprising exposing the pressure sensitive adhesive to actinic radiation to crosslink the epoxy-functional groups by means of the triazine crosslinker.

4. The method of claim 1 wherein the (meth)acrylic copolymer comprises 1 to 10 wt-% of polymerized units of a (meth)acryloyl monomer comprising an epoxy-functional group.

5. The method of claim 4 wherein the (meth)acryloyl monomer comprising the epoxy-functional group is of the formula: 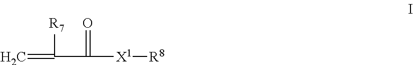
wherein:
R⁷ is —H or C₁-C₄ alkyl;
X¹ is —NR⁹— or —O—; and
R⁸ is an epoxy-substituted (hetero)hydrocarbyl group.

6. The method of claim 1 wherein the (meth)acrylic copolymer further comprises 1 to 10 wt-% acid-functional groups.

7. The method of claim 1 wherein the (meth)acrylic copolymer comprises less than 0.5 wt. % of acid-functional groups.

8. The method of claim 7 wherein the pressure sensitive adhesive comprises less than 0.5 wt.-% of acid-functional groups.

9. The method of claim 1 wherein the pressure sensitive adhesive is a pressure sensitive adhesive after crosslinking.

10. The method of claim 1 wherein the (meth)acrylic copolymer comprises at least 50 wt-% of polymerized units of (meth)acrylic acid ester monomers having a Tg less than 0° C.

11. The method of claim 1 wherein the pressure sensitive adhesive comprises a photoinitiator.

12. The method of claim 3 wherein the actinic radiation is ultraviolet radiation.

13. The method of claim 1 wherein the pressure sensitive adhesive further comprises 5 to 50 wt-% tackifier.

14. The method of claim 1 wherein the chlorinated triazine crosslinking agent is of the formula: 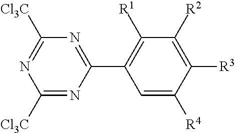
wherein:
R¹, R², R³, and R⁴ are independently hydrogen, alkl, or alkoxy; and
1-3 of the R¹, R², R³, and R⁴ groups are hydrogen.

15. An adhesive-coated article comprising
a substrate; and
a non-aqueous pressure sensitive adhesive comprising no greater than 5 wt-% polymerizable monomer disposed on the substrate, wherein the adhesive comprises
a) a (meth)acrylic copolymer comprising epoxy-functional groups; and a
b) a triazine crosslinker.

16. The adhesive-coated article of claim 15 wherein the substrate is a release liner or a backing.

17. (canceled)

18. A pressure sensitive adhesive composition comprising
a) a (meth)acrylic copolymer comprising epoxy-functional groups; and
b) a triazine crosslinker;
wherein the pressure sensitive adhesive is non-aqueous and comprises no greater than 5 wt-% polymerizable monomer.

19. The pressure sensitive adhesive of claim 18 wherein the epoxy-functional groups are crosslinked by means of the triazine crosslinker.

20. The pressure sensitive adhesive of claim 18 wherein the pressure sensitive adhesive further comprises a photoinitiator.

21. The method of claim 1 wherein the composition is a thermosettable adhesive composition.
